(19) United States
(12) Patent Application Publication
(10) Pub. No.: US 2025/0037139 A1
(43) Pub. Date: Jan. 30, 2025

(54) RESOURCE USAGE QUOTA ENFORCEMENT FOR ON-PREMISES AND CLOUD DEPLOYMENTS

(71) Applicant: VMWARE, INC., Palo Alto, CA (US)

(72) Inventors: ALEXANDER DIMITROV, Sofia (BG); ZORKA SHINDOVA, Sofia (BG); PLAMEN DIMITROV, Sofia (BG); SIMONA GEORGIEVA, Sofia (BG); ADELINA MATEEVA, Sofia (BG)

(21) Appl. No.: 18/225,183

(22) Filed: Jul. 24, 2023

(51) Int. Cl. G06Q 30/018

(52) U.S. Cl. CPC G06Q 30/018

(57) ABSTRACT

An example method may include generating a license key for a product that manages resources in a data center by encoding client product license data. The client product license data may include a first resource usage quota for an on-premises version of the product and a second resource usage quota for a cloud version of the product. Further, the method may include enabling activation of the on-premises version and the cloud version of the product using the licensed key. Furthermore, the method may include monitoring license usage data associated with the on-premises version and the cloud version. Further, the method may include analyzing the monitored license usage data to ensure compliance of the first resource usage quota and the second resource usage quota for the on-premises version and the cloud version, respectively.

### TECHNICAL FIELD

The present disclosure relates to computing environments, and more particularly to methods, techniques, and systems for enforcing a resource usage quota for on-premises and cloud deployments.

### BACKGROUND

In computing environments, on-premises deployed products use a perpetual license where a user buys a license of a given type, activates the license with a license key, and then uses the on-premises product. Such licenses may entitle the user to use the on-premises product within a specific quota (e.g., a number of managed resources). On the other hand, software-as-a-service (SaaS) products may have different licensing and subscription mechanisms. In SaaS, a license may be based on a subscription model where the user pays on a fixed (e.g., a monthly, yearly, or the like) basis for a cloud product usage. Due to the advantages of the SaaS products (e.g., high availability), the product vendors may push customers of the product from using the on-premises product to the SaaS product.

### BRIEF DESCRIPTION OF THE DRAWINGS

FIG. 1A is a block diagram of an example computing environment, depicting a management node to enforce a resource usage quota for on-premises and cloud deployments of a product;

FIG. 1B is a block diagram of an example computing environment of FIG. 1A, depicting additional features;

FIG. 2 is a block diagram of another example computing environment, depicting a subscription manager to enforce a resource usage quota for on-premises and cloud deployment of a product;

FIG. 3 is a sequence diagram illustrating a sequence of events to enforce a resource usage quota for on-premises and cloud deployments of a product;

FIG. 4 is a flow diagram illustrating an example method for monitoring license usage data associated with an on-premises version and a cloud version of a product to ensure compliance of client product license data; and

FIG. 5 is a block diagram of an example management node including non-transitory computer-readable storage medium storing instructions to monitor license usage data associated with a on-premises version and a cloud version of a product to ensure compliance of client product license data.

The drawings described herein are for illustrative purposes and are not intended to limit the scope of the present subject matter in any way.

### DETAILED DESCRIPTION

Examples described herein may provide an enhanced computer-based and/or network-based method, technique, and system to generate a hybrid license that allows activation of both an on-premises product and a SaaS product and enforce a resource usage quota for the on-premises product deployments and cloud product deployments in a computing environment. The paragraphs [0011] to [0015] present an overview of the computing environment, existing methods to enforce the resource usage quota for on-premises and cloud deployments of a product, and drawbacks associated with the existing methods.

The computing environment may be a virtual computing environment (e.g., a cloud computing environment, a virtualized environment, and the like). The virtual computing environment may be a pool or collection of cloud infrastructure resources designed for enterprise needs. The resources may be a processor (e.g., central processing unit (CPU)), memory (e.g., random-access memory (RAM)), storage (e.g., disk space), and networking (e.g., bandwidth). Further, the virtual computing environment may be a virtual representation of the physical data center, complete with servers, storage clusters, and networking components, all of which may reside in virtual space being hosted by one or more physical data centers. The virtual computing environment may include multiple physical computers (e.g., servers) executing different computing-instances or workloads (e.g., virtual machines, containers, and the like). The workloads may execute different types of applications or software products. Thus, the resource can be one of an infrastructure element and a business application, such as physical host computing systems, virtual machines, software defined data centers (SDDCs), containers, business applications, and/or the like.

Further, an on-premises data center may refer to a data center that is physically located in a business premises. For example, in an on-premises platform, resources may be deployed within a business premises (e.g., an organization). The information technology (IT) team of the organization may be responsible for maintaining the resources in the on-premises and carrying out routine maintenance services such as installing, updating security software, and the like. In some examples, an on-premises deployed product may use a perpetual license where a user buys a license to use the product indefinitely. In this example, the license entitles the user to use the product within a specific quota (e.g., the number of managed resources).

Furthermore, a cloud data center may be controlled and operated by a third-party cloud service provider such as Amazon Web Services (AWS), International Business Machines Corporation (IBM) Cloud, or the like. In some examples, a Cloud product may use a license, which may be based on a subscription model where the user pays on a fixed basis (e.g., monthly, yearly, or the like) for product usage. Further, there is a restriction on the number of resources that can be managed by the cloud product.

Due to the advantages of the SaaS products (e.g., high availability), the product vendors may want to move the users/customers from using the on-premises version of the product to using the SaaS version of the product. In such a scenario, the user may have to buy an additional license/subscription for the SaaS offering on top of the existing on-premises license. Also, the reporting or restriction of the resource usage is separate for both the on-premises version and the SaaS version and may not allow elastically to share the license between the on-premises product and the SaaS product, thereby preventing the adoption of the SaaS version of the product.

In some examples, a multi-cloud software-as-a-service (SaaS) management suite (e.g., VMware vRealize® Cloud Universal™) may be built to accelerate cloud adoption by combining on-premises and SaaS capabilities for automation, operations, log analytics, network visibility, cost optimization, security, and compliance into one license (e.g., a universal license). The multi-cloud SaaS management suite may provide the flexibility to deploy on-premises or as SaaS, interchangeably, without the need to repurchase, for a consistent hybrid and multi-cloud management experience. The flexible licensing and delivery models enable organizations to move at their own pace, helping them to become more agile, scalable, and efficient. However, in such example scenarios, tracking the users' on-premises/SaaS usage ratios, overall billing, and compliance with the resource usage quota may be challenging for the vendor.

Examples described herein may provide a method to enforce a resource usage quota for on-premises and cloud deployments. The method may include generating a license key for a product that manages resources in a data center by encoding client product license data. In an example, the client product license data may include a first resource usage quota for an on-premises version of the product and a second resource usage quota for a cloud version of the product. Further, the method may include enabling activation of the on-premises version and the cloud version of the product using the licensed key. Furthermore, the method may include monitoring license usage data associated with the on-premises version and the cloud version. Further, the method may include analyzing the monitored license usage data to ensure compliance of the first resource usage quota and the second resource usage quota for the on-premises version and the cloud version, respectively. Thus, examples described herein may provide the user to track the users' on-premises/SaaS usage ratios, overall billing, and compliance with the resource usage quotas.

In the following description, for purposes of explanation, numerous specific details are set forth in order to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

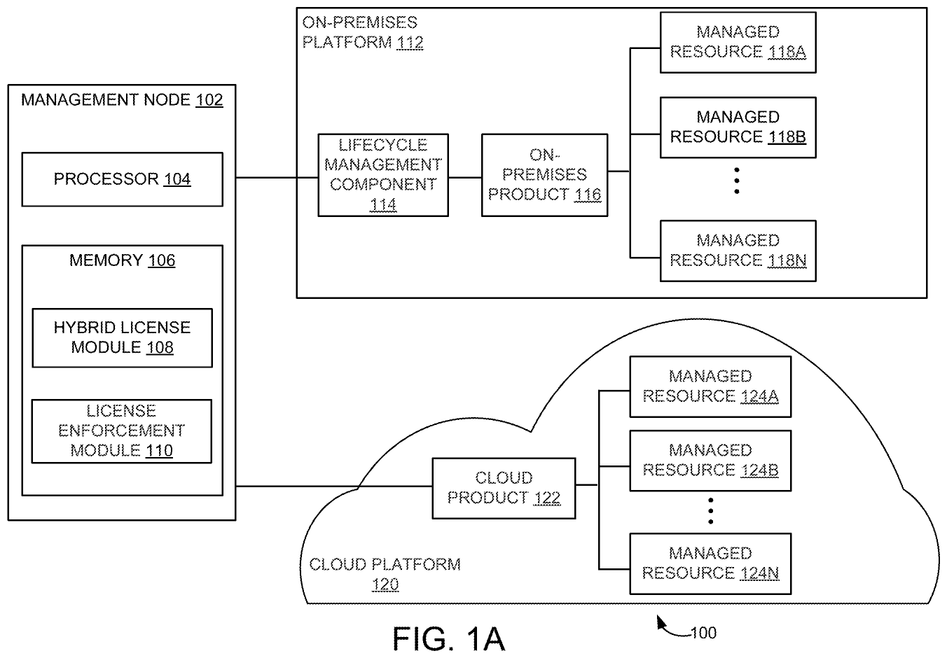

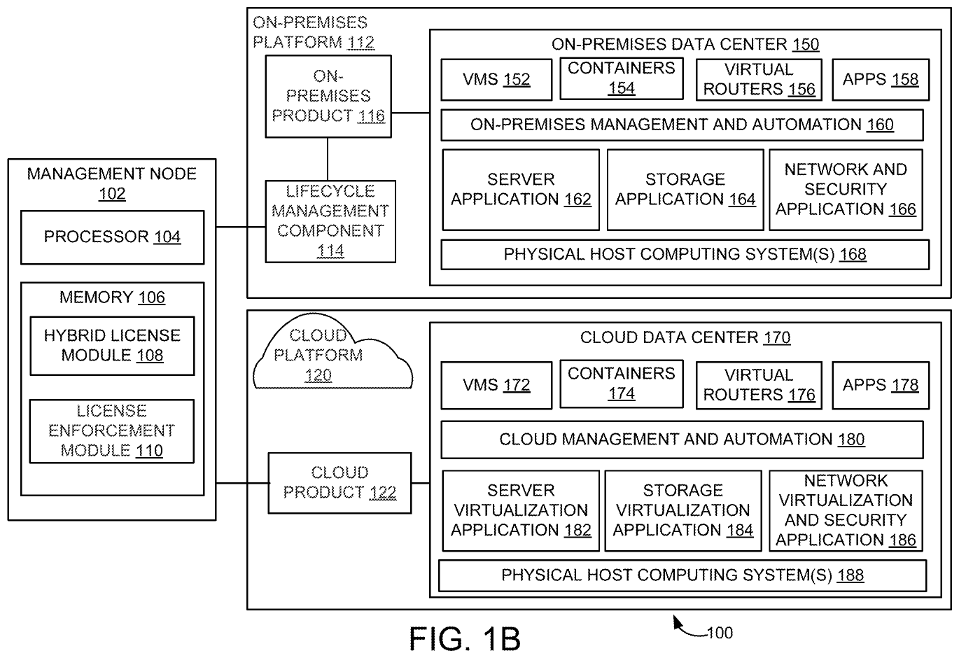

Referring now to the figures, FIG. 1A is a block diagram of an example computing environment 100, depicting a management node 102 to enforce a resource usage quota for on-premises and cloud deployments of a product. Example computing environment 100 may be based on the deployment of resources (e.g., resources 118N-118N and resources 124A-124N) on an on-premises platform 112 and a cloud platform 120. In an example, the resources (e.g., resources 118N-118N and resources 124A-124N) may include compute resources, network resources, or a combination thereof. For example, the resources may include compute resources such as data centers, host computers, machines (e.g., virtual machines, Pods, containers, and the like executing on host computers), standalone servers, processors of host computers, processor cores of processors, graphical processing units, co-processors, memories of host computers and/or storages. In other examples, the resources may include network elements such as gateways, routers, switches, middlebox service machines and appliances, and the like.

In on-premises platform 112, resources (e.g., 118A-118N) may be deployed within a business premises. Further, on-premises platform 112 may include a lifecycle management component 114 to manage lifecycle of on-premises product 116 (e.g., install, activate, license, collect product usage, and the like) and corresponding resources (e.g., resources 118A-118N). On-premises product 116 may manage resources 118A-118N that belongs to a host or cluster in on-premises platform 112.

An example cloud platform 120 may refer to an operating system and hardware of a server in an Internet-based data center. For example, in example cloud platform 120, resources (e.g., 124A-124N) may be deployed on a third-party server. In some examples, cloud platform 120 may support different cloud products (e.g., a cloud product 122) to provide various cloud services for resources (e.g., 124A-124N). Cloud product 122 may manage resources 124A-124N that belongs to a host or cluster in cloud platform 120.

Further, a multi-cloud software-as-a-service (SaaS) management suite (e.g., VMware vRealize® Cloud Universal™) may be built to accelerate cloud adoption by combining on-premises and SaaS capabilities for automation, operations, log analytics, network visibility, cost optimization, security, and compliance into one license. For example, a universal license may be generated that provides users the flexibility to manage the resources regardless of whether they are on premises (e.g., on VMware vSphere), third-party hypervisors, physical servers, or supported public clouds.

As shown in FIG. 1A, computing environment 100 may include management node 102 communicatively connected to on-premises platform 112 and cloud platform 120 via a network. An example network can be a managed Internet protocol (IP) network administered by a service provider. For example, the network may be implemented using wireless protocols and technologies, such as Wi-Fi, WiMAX, and the like. In other examples, the network can also be a packet-switched network such as a local area network, wide area network, metropolitan area network, Internet network, or other similar type of network environment. In yet other examples, the network may be a fixed wireless network, a wireless local area network (LAN), a wireless wide area network (WAN), a personal area network (PAN), a virtual private network (VPN), intranet or other suitable network system and includes equipment for receiving and transmitting signals.

Further, management node 102 may include a processor 104. Processor 104 may refer to, for example, a central processing unit (CPU), a semiconductor-based microprocessor, a digital signal processor (DSP) such as a digital image processing unit, or other hardware devices or processing elements suitable to retrieve and execute instructions stored in a storage medium, or suitable combinations thereof. Processor 104 may, for example, include single or multiple cores on a chip, multiple cores across multiple chips, multiple cores across multiple devices, or suitable combinations thereof. Processor 104 may be functional to fetch, decode, and execute instructions as described herein. Further, management node 102 includes memory 106 coupled to processor 104. In an example, memory 106 includes a hybrid license module 108 and a license enforcement module 110.

During operation, hybrid license module 108 may receive client product license data associated with a product that manages resources in a data center. An example product may include CloudHealth® (i.e., VMware's cloud service management platform), CloudHealth Secure State™ (i.e., VMware's cloud security monitoring service), VMware vRealize Automation™ or vRealize Automation Cloud™ (i.e., VMware's infrastructure automation platform), VMware vRealize Operations™ or vRealize Operations Cloud™ (i.e., VMware's virtualized environment monitoring and management platform), VMware vRealize Log Insight™ or vRealize Log Insight Cloud™ (i.e., VMware's log management platform), VMware vRealize Network Insight Cloud™ (i.e., VMware's network monitoring platform), and the like. Such products can manage/monitor resources deployed in on-premises platform 112 or resources deployed in cloud platform 120.

In an example, the client product license data may include a first resource usage quota for an on-premises version of the product (e.g., on-premises product 116) and a second resource usage quota for a cloud version of the product (e.g., cloud product 122). For example, the client product license data may include a total resource usage quota that is divided between the first resource usage quota and the second resource usage quota allocated according to a predefined ratio. The first resource usage quota may define a maximum number of managed resources that can be assigned to on-premises product 116 and the second resource usage quota may define a maximum number of managed resources that can be assigned to cloud product 122.

For example, consider that the client product license data includes the total resource usage quota as 1000 managed resources and the predefined ratio as 60:40%. In this example, on-premises product 116 can manage 600 managed resources in on-premises platform 112 and cloud product 122 can manage 400 managed resources in cloud platform 120. The predefined ratio may be defined based on on-premises and cloud deployments of the user. In some examples, the predefined ratio can be changed based on user's request.

Further, hybrid license module 108 may generate a license key for the product by encoding the client product license data. In an example, the license key may be used to activate the product (i.e., on-premises version 116 and cloud version 122) to manage the resources deployed in on-premises platform 112 and in cloud platform 120. Thus, the license key may act as a universal license corresponding to both on-premises version 116 and cloud version 122 of the product. Furthermore, hybrid license module 108 may provide the license key to a user to activate the on-premises version 116 and the cloud version 122 of the product.

Further in operation, hybrid license module 108 may monitor license usage data associated with the on-premises version 116 and the cloud version 122. In an example, hybrid license module 108 may communicate with lifecycle management component 114 that manages the lifecycle of on-premises version 116 to receive first license usage data associated with on-premises version 116 of the product. Further, hybrid license module 108 may communicate with a cloud service that manages a lifecycle of cloud version 122 to receive second license usage data associated with cloud version 122 of the product.

In an example, hybrid license module 108 may be a cloud utility service that integrates with lifecycle management component 114 of on-premises platform to collect data for on-premises version 116. Hybrid license module 108 may also integrate with a respective cloud service to monitor license data usage for cloud version 122. Further, hybrid license module 108 may manage license subscriptions and visualize license consumption associated with on-premises version 116 and cloud version 122. Hybrid license module 108 may also automate license usage metering from a product deployment on premises and in the cloud.

Furthermore, hybrid license module 108 may determine available resource usage quota associated with on-premises version 116 and cloud version 122 based on the monitored license usage data, the first resource usage quota, and the second resource usage quota. In this example, hybrid license module 108 may determine available resource usage quota associated with on-premises version 116 based on the monitored license usage data of on-premises version 116 and the first resource usage quota. Further, hybrid license module 108 may determine available resource usage quota associated with cloud version 122 based on the monitored license usage data of cloud version 122 and the second resource usage quota. Further, hybrid license module 108 may communicate a report including the monitored license usage data and the available resource usage quota associated with on-premises version 116 and cloud version 122 to the user of the product.

Thus, the client uses the license key to activate both the on-prem product deployment and the SaaS product deployment. The license key is used to identify the client so the system can track the product usage. By collecting and reporting the actual on-prem and SaaS product usage, the client can have his subscription fee match the combined actual product usage, for instance, without overpaying or underpaying for the product usage.

Further during operation, license enforcement module 110 may enforce the first resource usage quota and the second resource usage quota for the product based on the monitored license usage data. The product license enforcement may be a mechanism or mechanisms that are used to manage product license compliance. An enforcement mechanism may result in some experience to users of the product to let them know if they are using the product (e.g., on-premises version 116 and cloud version 122) outside the bounds of the software license agreement. In an example, license enforcement module 110 may perform enforcement of the first resource usage quota for on-premises version 116 of the product based on the first license usage data. Further, license enforcement module 110 may perform enforcement of the second resource usage quota for cloud version 122 of the product based on the second license usage data.

Further, license enforcement module 110 may prevent addition of a new resource to on-premises version 116 of the product when the license data usage of on-premises version 116 exceeds the first resource usage quota. In response to preventing the addition of the resource to on-premises version 116, license enforcement module 110 may send a license violation notification to the user of the product. In another example, license enforcement module 110 may prevent addition of a new resource to cloud version 122 of the product when the license data usage of cloud version 122 exceeds the second resource usage quota. In response to preventing the addition of the resource to cloud version 122, license enforcement module 110 may send a license violation notification to the user of the product.

In some examples, the functionalities described in FIG. 1A, in relation to instructions to implement functions of hybrid license module 108, license enforcement module 110, and any additional instructions described herein in relation to the storage medium, may be implemented as engines or modules including any combination of hardware and programming to implement the functionalities of the modules or engines described herein. The functions of hybrid license module 108 and license enforcement module 110 may also be implemented by a processor. In examples described herein, the processor may include, for example, one processor or multiple processors included in a single device or distributed across multiple devices.

Further, the computing environment illustrated in FIG. 1A is shown purely for purposes of illustration and is not intended to be in any way inclusive or limiting to the embodiments that are described herein. For example, a typical computing environment would include many more remote servers (e.g., resources), which may be distributed over multiple data centers, which might include many other types of devices, such as switches, power supplies, cooling systems, environmental controls, and the like, which are not illustrated herein. It will be apparent to one of ordinary skill in the art that the example shown in FIG. 1A, as well as all other figures in this disclosure have been simplified for ease of understanding and are not intended to be exhaustive or limiting to the scope of the idea.

FIG. 1B is a block diagram of an example computing environment 100 of FIG. 1A, depicting additional features. Similarly named elements of FIG. 1B may be similar in structure and/or function to elements described in FIG. 1A. Computing environment 100 may be based on deployment of resources across on-premises platform 112 and cloud platform 120. In an example, on-premises platform 112 may include an an-premises data center 150. An-premises data center 150 may refer to a centralized physical facility where servers, network, storage, and other information technology equipment that support business operations exist. Further, components in data center 150 include or facilitate business-critical applications, services, data, and the like. For example, on-premises data center 150 may include different components such as a server application 162, a storage application 164, a network and security application 166, physical host computing system(s) 168 (e.g., ESXi servers), or any combination thereof. Further, on-premises data center 150 may include an on-premises management and automation platform 160 to deploy different components and manage different workloads/resources such as virtual machines 152, containers 154, virtual routers 156, applications 158, and the like.

Example cloud platform 120 may include a cloud data center 170. Example cloud data center 170 may be based on the deployment of physical resources across a network, virtualizing the physical resources into virtual resources, and provisioning the virtual resources in cloud data center 170 for use across cloud computing services and applications. For example, cloud data center 170 may be a software-defined data center (SDDC) with hyperconverged infrastructure (HCI). In SDDC with hyper-converged infrastructure, networking, storage, processing, and security may be virtualized and delivered as a service. The hyper-converged infrastructure may combine a virtualization platform such as a hypervisor, virtualized software-defined storage, and virtualized networking in cloud data center 170 deployment. For example, cloud data center 170 may include different components such as a server virtualization application 182 (e.g., vSphere of VMware®), a storage virtualization application 184 (e.g., vSAN of VMware®), a network virtualization and security application 186 (e.g., NSX of VMware®), physical host computing system(s) 188 (e.g., ESXi servers), or any combination thereof.

Further, cloud data center 170 may include a cloud management and automation platform 180 to deploy different components and manage different workloads/resources such as virtual machines 172, containers 174, virtual routers 176, applications 178, and the like. The virtual machines (e.g., virtual machines 152 and 172), in some examples, may operate with their own guest operating systems on a physical computing device using resources of the physical computing device virtualized by virtualization software (e.g., a hypervisor, a virtual machine monitor, and the like). The containers (e.g., containers 154 and 174) are data computer nodes that run on top of the host operating systems without the need for a hypervisor or separate operating system. In some examples, cloud data center 170 may include one or more workload domains, each workload domain representing a logical unit that groups physical computing devices managed by management node 102 (e.g., vCenter server) with specific characteristics according to SDDC polices.

An example platform to deploy and manage cloud data center 170 may include VMware Cloud Foundation™ (VCF), which is commercially available from VMware. VCF may be a hybrid cloud platform that provides a full stack hyperconverged infrastructure that is made for modernizing data centers and deploying modern container-based applications. VCF integrates different components like vSphere (compute), vSAN (storage), NSX (networking), and some parts of the vRealize Suite in a hyper-converged infrastructure solution with infrastructure automation and software lifecycle management. The idea of VCF follows a standardized, automated, and validated approach that simplifies the management of the needed software-defined infrastructure resources. So, VCF is fully integrated software composed of vSphere, NSX, vSAN, and SDDC manager based on the concepts of HCI, which accelerates the delivery of virtual infrastructure (VI) or virtual desktop infrastructure (VDI).

As shown in FIG. 1B, on-premises data center 150 and cloud data center 170 may be communicatively connected to management node 102 via the network. Further, management node 102 may include processor 104 and memory 106 as described in FIG. 1A. During operation, hybrid license module 108 and license enforcement module 110 may facilitate in enforcing resource usage quota for on-premises and cloud deployments of the product.

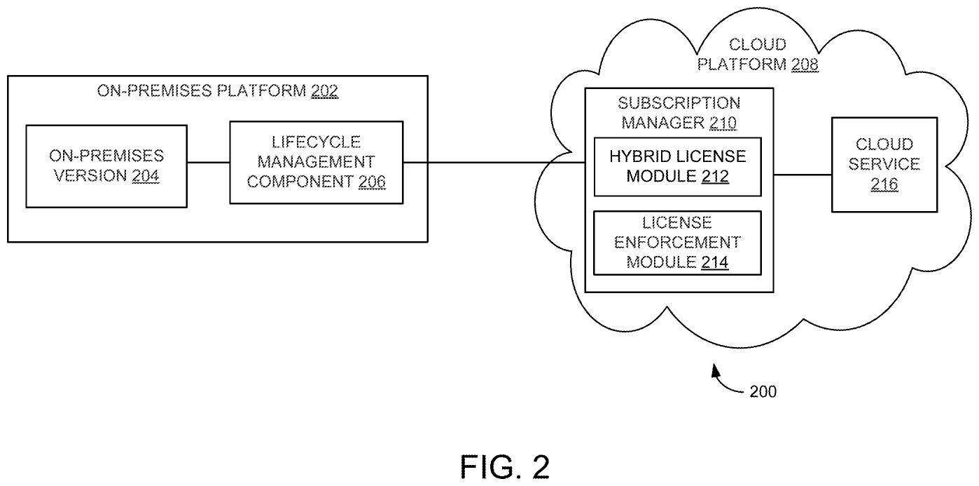

FIG. 2 is a block diagram of another example computing environment 200, depicting a subscription manager 210 to enforce a resource usage quota for on-premises (e.g., on-premises version 204) and cloud (e.g., cloud service 216) deployment of a product. Example computing environment 200 may include an on-premises platform 202 and a cloud platform 208. In an example, on-premises platform 202 may include an on-premises version 204 of a product that manages resources (e.g., VMs) deployed in on-premises platform 202 and cloud platform 208 may include cloud service 216 of the product that manages resources (e.g., VMs) deployed in cloud platform 208. Further, on-premises platform 202 may include a lifecycle management component 206 to manage different components (e.g., lifecycle of on-premises version 204) of on-premises platform 202. Furthermore, cloud platform 208 may include subscription manager 210. In an example, subscription manager 210 may include a hybrid license module 212 and a license enforcement module 214 to manage license usage associated with the product.

In an example, subscription manager 210 (e.g., vRealize Cloud Subscription Manager of VMware) may be a cloud utility service that integrates with lifecycle management component 206 (e.g., VMware's vRealize Suite Lifecycle Manager) to collect data for on-premises version 204. Further, subscription manager 210 may integrate with respective cloud services (e.g., cloud service 216) to monitor license data usage for cloud service 216. Thus, subscription manager 210 may manage hybrid licenses (e.g., vRealize Cloud Universal subscriptions) and visualize consumption of cloud components (e.g., vRealize Cloud components). Also, subscription manager 210 may automate license usage metering from deployments in on-premises platform 202 and cloud platform 208. Thus, examples described herein may provide subscription manager 210 to collect product usage data from the on-premises and SaaS product, aggregate the usage and track any license quota violations (i.e., any breaches of entitled quota).

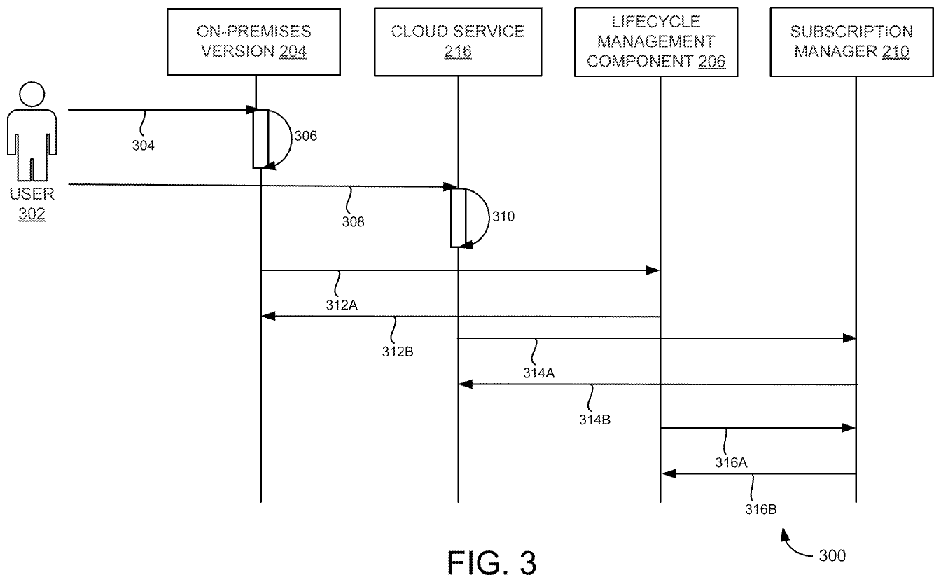

FIG. 3 is a sequence diagram 300 illustrating sequence of events to enforce a resource usage quota for on-premises and cloud deployment of a product. For example, similarly named elements of FIG. 3 may be similar in structure and/or function to elements described with respect to FIG. 2. Example sequence diagram 300 may represent the interactions and the operations involved in enforcing the resource usage quota for on-premises version 204 and cloud version 216 deployment of the product. FIG. 3 illustrates process objects including on-premises version 204, cloud service 216, lifecycle management component 206, and subscription manager 210 along with their respective vertical lines originating from them. The vertical lines of on-premises version 204, cloud service 216, lifecycle management component 206, and subscription manager 210 may represent the processes that may exist simultaneously. The horizontal arrows (e.g., 304, 308, 312A, 312B, 314A, 314B, 316A, and 316B) may represent the data flow steps between the vertical lines originating from their respective process objects (for e.g., on-premises version 204, cloud service 216, lifecycle management component 206, and subscription manager 210). Further, activation boxes (e.g., 306 and 310) between the horizontal arrows may represent the process that is being performed in the respective process object.

At 304, a user 302 with a universal license may install (e.g., at 306) on-premises version 204 (e.g., vRA on-premises) on an on-premises platform. At 308, user 302 may activate (e.g., at 310) cloud service 216 with the same universal license.

At 312A, lifecycle management component 206 may periodically collect on-premises version usage metrics. Further, on-premises version 204 may receive information about available resource quota in the on-premises platform from lifecycle management component 206, at 312B.

At 314A, subscription manager 210 may periodically collect cloud service usage metrics. Further, cloud service 216 may receive information about available resource quota in the cloud platform from subscription manager 210, at 314B.

At 316A, lifecycle management component 206 periodically reports on-premises version 204 usage data to subscription manager 210. Further, lifecycle management component 206 may receive information about the available resource quota from subscription manager 210, at 316B. Thus, examples described herein may provide a method to collect product usage data from the on-premises and the SaaS product and send it to a common component (i.e., the subscription manager) that aggregates the usage and tracks any license quota violations.

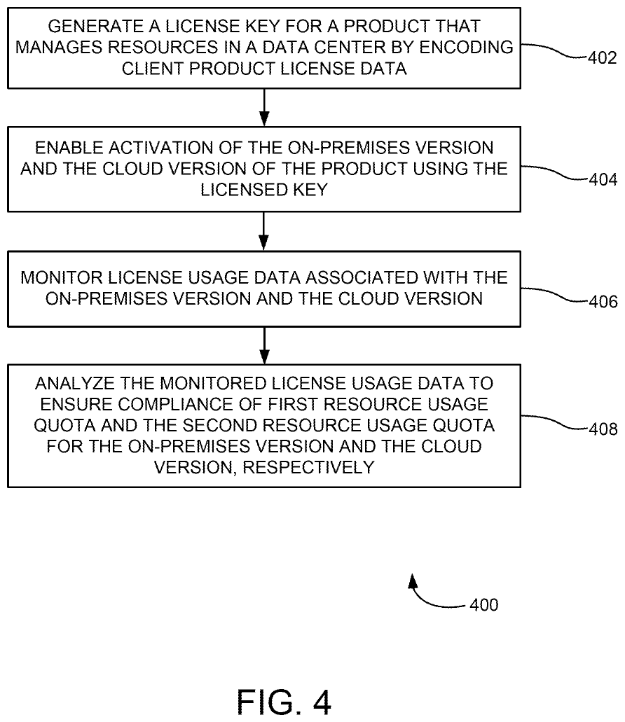

FIG. 4 is a flow diagram illustrating an example method 400 for monitoring license usage data associated with an on-premises version and a cloud version of a product to ensure compliance of client product license data. Example method 400 depicted in FIG. 4 represents generalized illustrations, and other processes may be added, or existing processes may be removed, modified, or rearranged without departing from the scope and spirit of the present application. In addition, method 400 may represent instructions stored on a computer-readable storage medium that, when executed, may cause a processor to respond, to perform actions, to change states, and/or to make decisions. Alternatively, method 400 may represent functions and/or actions performed by functionally equivalent circuits like analog circuits, digital signal processing circuits, application specific integrated circuits (ASICs), or other hardware components associated with the system. Furthermore, the flow chart is not intended to limit the implementation of the present application, but the flow chart illustrates functional information to design/fabricate circuits, generates computer-readable instructions, or uses a combination of hardware and computer-readable instructions to perform the illustrated processes.

At 402, a license key for a product that manages resources in a data center may be generated by encoding client product license data. In an example, the client product license data may include a first resource usage quota for an on-premises version of the product and a second resource usage quota for a cloud version of the product. For example, the client product license data may include a total resource usage quota that is divided between the first resource usage quota and the second resource usage quota allocated according to a predefined ratio.

At 404, activation of the on-premises version and the cloud version of the product may be enabled using the licensed key. At 406, license usage data associated with the on-premises version and the cloud version may be monitored. In an example, monitoring the license usage data may include communicating with a lifecycle management component that manages a lifecycle of the on-premises version to receive first license usage data associated with the on-premises version of the product. Further, a cloud service that manages a lifecycle of the cloud version may be communicated to receive second license usage data associated with the cloud version of the product.

At 408, the monitored license usage data may be analyzed to ensure compliance of first resource usage quota and the second resource usage quota for the on-premises version and the cloud version, respectively. In an example, based on analyzing the monitored license usage data, any violation to the first resource usage quota and the second resource usage quota found on the on-premises version and the cloud version, respectively, may be reported.

In an example, available resource usage quota associated with the on-premises version and the cloud version may be determined based on the monitored license usage data, the first resource usage quota, and the second resource usage quota. Further, a report including the monitored license usage data and the available resource usage quota associated with the on-premises version and the cloud version may be communicated to a user of the product.

For example, addition of a resource to the on-premises version of the product may be prevented when the license data usage of the on-premises version exceeds the first resource usage quota. In response to preventing addition of the resource to the on-premises version, a license violation notification may be sent to a user of the product.

In another example, addition of a resource to the cloud version of the product may be prevented when the license data usage of the cloud version exceeds the second resource usage quota. In response to preventing addition of the resource to the cloud version, a license violation notification may be sent to a user of the product.

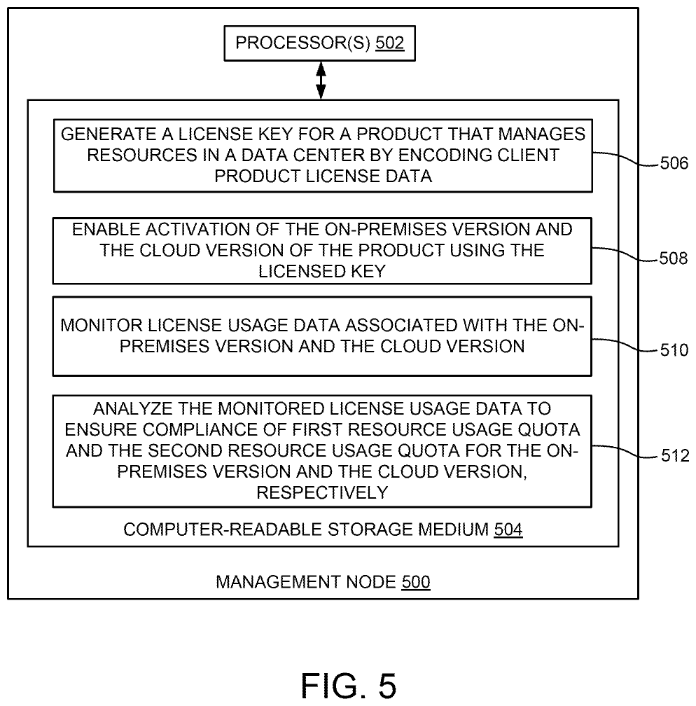

FIG. 5 is a block diagram of an example management node including non-transitory computer-readable storage medium 504 storing instructions to monitor license usage data associated with a on-premises version and a cloud version of a product to ensure compliance of client product license data. Management node 500 may include a processor 502 and computer-readable storage medium 504 communicatively coupled through a system bus. Processor 502 may be any type of central processing unit (CPU), microprocessor, or processing logic that interprets and executes computer-readable instructions stored in computer-readable storage medium 504. Computer-readable storage medium 504 may be a random-access memory (RAM) or another type of dynamic storage device that may store information and computer-readable instructions that may be executed by processor 502. For example, computer-readable storage medium 504 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, computer-readable storage medium 504 may be a non-transitory computer-readable medium. In an example, computer-readable storage medium 504 may be remote but accessible to management node 500.

Computer-readable storage medium 504 may store instructions 506, 508, 510, and 512. Instructions 506 may be executed by processor 502 to generate a license key for a product that manages resources in a data center by encoding client product license data. In an example, the client product license data may include a first resource usage quota for an on-premises version of the product and a second resource usage quota for a cloud version of the product. For example, the client product license data may include a total resource usage quota that is divided between the first resource usage quota and the second resource usage quota allocated according to a predefined ratio.

Instructions 508 may be executed by processor 502 to enable activation of the on-premises version and the cloud version of the product using the licensed key. Instructions 510 may be executed by processor 502 to monitor license usage data associated with the on-premises version and the cloud version. Instructions 512 may be executed by processor 502 to analyze the monitored license usage data to ensure compliance of the first resource usage quota and the second resource usage quota for the on-premises version and the cloud version, respectively.

Further, computer-readable storage medium 504 may store instructions to report any violation to the first resource usage quota and the second resource usage quota found on the on-premises version and the cloud version, respectively based on analyzing the monitored license usage data.

For example, computer-readable storage medium 504 may store instructions to determine available resource usage quota associated with the on-premises version and the cloud version based on the monitored license usage data, the first resource usage quota, and the second resource usage quota. Further, computer-readable storage medium 504 may store instructions to communicate a report including the monitored license usage data and the available resource usage quota associated with the on-premises version and the cloud version to a user of the product.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus. In addition, the terms “first” and “second” are used to identify individual elements and may not meant to designate an order or number of those elements.

The present description has been shown and described with reference to the foregoing examples. It is understood, however, that other forms, details, and examples can be made without departing from the spirit and scope of the present subject matter that is defined in the following claims.

What is claimed is:

1. A method comprising:
generating a license key for a product that manages resources in a data center by encoding client product license data, wherein the client product license data comprises a first resource usage quota for an on-premises version of the product and a second resource usage quota for a cloud version of the product;
enabling activation of the on-premises version and the cloud version of the product using the licensed key;
monitoring license usage data associated with the on-premises version and the cloud version; and
analyzing the monitored license usage data to ensure compliance of the first resource usage quota and the second resource usage quota for the on-premises version and the cloud version, respectively.

2. The method of claim 1, further comprising:
based on analyzing the monitored license usage data, reporting any violation to the first resource usage quota and the second resource usage quota found on the on-premises version and the cloud version, respectively.

3. The method of claim 1, further comprising:
determining available resource usage quota associated with the on-premises version and the cloud version based on the monitored license usage data, the first resource usage quota, and the second resource usage quota; and
communicating a report including the monitored license usage data and the available resource usage quota associated with the on-premises version and the cloud version to a user of the product.

4. The method of claim 1, wherein the client product license data comprises a total resource usage quota that is divided between the first resource usage quota and the second resource usage quota allocated according to a predefined ratio.

5. The method of claim 1, wherein monitoring the license usage data comprises:
communicating with a lifecycle management component that manages a lifecycle of the on-premises version to receive first license usage data associated with the on-premises version of the product; and
communicating with a cloud service that manages a lifecycle of the cloud version to receive second license usage data associated with the cloud version of the product.

6. The method of claim 5, further comprising:
preventing addition of a resource to the on-premises version of the product when the license data usage of the on-premises version exceeds the first resource usage quota; and
in response to preventing addition of the resource to the on-premises version, sending a license violation notification to a user of the product.

7. The method of claim 5, further comprising:
preventing addition of a resource to the cloud version of the product when the license data usage of the cloud version exceeds the second resource usage quota; and
in response to preventing addition of the resource to the cloud version, sending a license violation notification to a user of the product.

8. A management node comprising:
a processor; and
memory coupled to the processor, wherein the memory comprises:
a hybrid license module to:
receive client product license data associated with a product that manages resources in a data center, wherein the client product license data comprises a first resource usage quota for an on-premises version of the product and a second resource usage quota for a cloud version of the product;
generate a license key for the product by encoding the client product license data;
provide the license key to a user to activate the on-premises version and the cloud version of the product; and
monitor license usage data associated with the on-premises version and the cloud version; and
a license enforcement module to:
enforce the first resource usage quota and the second resource usage quota for the product based on the monitored license usage data.

9. The management node of claim 8, wherein the hybrid license module is to:
determine available resource usage quota associated with the on-premises version and the cloud version based on the monitored license usage data, the first resource usage quota, and the second resource usage quota; and
communicate a report including the monitored license usage data and the available resource usage quota associated with the on-premises version and the cloud version to the user of the product.

10. The management node of claim 8, wherein the client product license data comprises a total resource usage quota that is divided between the first resource usage quota and the second resource usage quota allocated according to a predefined ratio.

11. The management node of claim 8, wherein the hybrid license module is to:
communicate with a lifecycle management component that manages a lifecycle of the on-premises version to receive first license usage data associated with the on-premises version of the product; and
communicate with a cloud service that manages a lifecycle of the cloud version to receive second license usage data associated with the cloud version of the product.

12. The management node of claim 11, wherein the license enforcement module is to:
perform enforcement of the first resource usage quota for the on-premises version of the product based on the first license usage data; and
perform enforcement of the second resource usage quota for a cloud version of the product based on the second license usage data.

13. The management node of claim 8, wherein the license enforcement module is to:
prevent addition of a resource to the on-premises version of the product when the license data usage of the on-premises version exceeds the first resource usage quota; and
in response to preventing addition of the resource to the on-premises version, send a license violation notification to the user of the product.

14. The management node of claim 8, wherein the license enforcement module is to:
prevent addition of a resource to the cloud version of the product when the license data usage of the cloud version exceeds the second resource usage quota; and
in response to preventing addition of the resource to the cloud version, send a license violation notification to the user of the product.

15. The management node of claim 8, wherein the license key is used to activate the product to manage the resources deployed in an on-premises platform and in a cloud platform.

16. The management node of claim 8, wherein the resources comprise compute resources, network resources, or a combination thereof.

17. A non-transitory computer-readable storage medium having instructions executable by a processor of a management node to:
generate a license key for a product that manages resources in a data center by encoding client product license data, wherein the client product license data comprises a first resource usage quota for an on-premises version of the product and a second resource usage quota for a cloud version of the product;
enable activation of the on-premises version and the cloud version of the product using the licensed key;
monitor license usage data associated with the on-premises version and the cloud version; and
analyze the monitored license usage data to ensure compliance of first resource usage quota and the second resource usage quota for the on-premises version and the cloud version, respectively.

18. The non-transitory computer-readable storage medium of claim 17, further comprising instructions to:
based on analyzing the monitored license usage data, report any violation to the first resource usage quota and the second resource usage quota found on the on-premises version and the cloud version, respectively.

19. The non-transitory computer-readable storage medium of claim 17, further comprising instructions to:
determine available resource usage quota associated with the on-premises version and the cloud version based on the monitored license usage data, the first resource usage quota, and the second resource usage quota; and
communicate a report including the monitored license usage data and the available resource usage quota associated with the on-premises version and the cloud version to a user of the product.

20. The non-transitory computer-readable storage medium of claim 17, wherein the client product license data comprises a total resource usage quota that is divided between the first resource usage quota and the second resource usage quota allocated according to a predefined ratio.
